(19) United States
(12) Patent Application Publication
(10) Pub. No.: US 2012/0315470 A1
(43) Pub. Date: Dec. 13, 2012

(54) CARRIER MATERIAL FOR THIN LAYER BASE MATERIAL

(75) Inventors: Ikkou HANAKI, Ibaraki-shi (JP); Hiroyuki WATANABE, Ibaraki-shi (JP)

(73) Assignee: NITTO DENKO CORPORATION, Osaka (JP)

(21) Appl. No.: 13/493,382

(22) Filed: Jun. 11, 2012

(30) Foreign Application Priority Data
Jun. 10, 2011 (JP) 2011-130251

(51) Int. Cl. C09J 7/02; B32B 5/00

(52) U.S. Cl. 428/337

(57) ABSTRACT

The present invention provides a carrier material for a thin layer base material, which does not cause defects such as generation of wrinkles and scratches, and impossibility of shape retention even in the case of using a thin layer base material in processing step, transporting step or the like in the state of being bonded to a carrier material, and is also excellent in workability. Disclosed is a carrier material for a thin layer base material, including a support having a thickness of 50 to 150 μm and formed from a polyester-based resin, and a pressure-sensitive adhesive layer formed on at least one surface of the support.

### BACKGROUND OF THE INVENTION

1. Field of the Invention

The present invention relates to a support having a specific thickness and formed from a specific resin, and a carrier material for a thin layer base material, including a pressure-sensitive adhesive layer.

2. Description of the Related Art

In touch panels, liquid crystal display panels, organic EL panels, electrochromic panels, electronic paper elements and the like, demands for elements using a film substrate obtained by providing a transparent electrode on a plastic panel have recently been increasing.

An ITO thin film (In—Sn composite oxide) is now mainly used as a material of a transparent electrode, and a thickness of a thin film base material including the above ITO thin film tends to become thin year by year.

Under these circumstances, a surface protective film or the like is used in the state of being bonded to an optical member such as an ITO thin film in processing step, transporting step or the like for the purpose of preventing scratches, stains and the like. For example, Patent Document 1 discloses that a thin surface protective film is used in the state of being bonded to an optical member.

Patent Document 1: JP-A-2007-304317

However, as the thickness of a thin film base material such as the above ITO thin film decreases, stiffness of the thin film base material per se is lost. For example, a protective film (carrier material) formed from a support (base material) and a pressure-sensitive adhesive layer is used in processing step, transporting step or the like in the state of being bonded to the ITO thin film, generation of defects such as generation of wrinkles, impossibility of shape retention, and generation of scratches or the like becomes a problem. There also arises a problem that workability drastically deteriorate since the thin film base material has no stiffness.

### SUMMARY OF THE INVENTION

### Problems to be Solved by the Invention

Thus, an object of the present invention is to provide a carrier material for a thin layer base material, which does not causes generation of wrinkles, scratches and the like and is capable of retaining the shape of a thin layer base material even in the case of using the thin layer base material in processing step, transporting step or the like in the state of being bonded to a carrier material, and is also excellent in workability.

### Means for Solving the Problems

The present inventors have intensively studied so as to achieve the above object and found that the above object can be achieved by using the carrier material for a thin layer base material of the present invention, and thus the present invention has been completed.

That is, the carrier material for a thin layer base material of the present invention includes a support having a thickness of 50 to 150 μm and formed from a polyester-based resin, and a pressure-sensitive adhesive layer formed on at least one surface of the support.

In the carrier material for a thin layer base material of the present invention, the total of a breaking strength in a first direction and a breaking strength in a second direction perpendicularly intersecting with the first direction of the support is preferably from 300 to 700 N/10 mm.

In the carrier material for a thin layer base material of the present invention, the pressure-sensitive adhesive layer preferably has an initial adhesive power (after 30 minutes at 23° C.) of 0.5 N/25 mm or less.

In the carrier material for a thin layer base material of the present invention, the support preferably contains polyethylene terephthalate.

In the carrier material for a thin layer base material of the present invention, the thin layer base material is preferably a resin film.

In the carrier material for a thin layer base material of the present invention, the thin layer base material is preferably a base material for an optical device.

### Effect of the Invention

The carrier material for a thin layer base material of the present invention becomes a carrier material, which does not cause generation of wrinkles, scratches and the like and is capable of retaining the shape of a thin layer base material even in the case of using the thin layer base material in processing step, transporting step or the like in the state of being bonded to a carrier material, and is also excellent in workability, by using a support having a specific thickness and formed from a specific resin. Therefore, the carrier material for a thin layer base material of the present invention is useful.

### BRIEF DESCRIPTION OF THE DRAWING

FIG. 1 is a phase diagram in which an ITO film is bonded on a top surface of a carrier material for a thin layer base material.

### DETAILED DESCRIPTION OF THE PREFERRED EMBODIMENTS

Embodiments of present invention will be described in detail below.

The carrier material for a thin layer base material of the present invention includes a support having a thickness of 50 to 150 μm and formed from a polyester-based resin, and a pressure-sensitive adhesive layer formed on at least one surface of the support.

It is possible to use any of pressure-sensitive adhesives such as acrylic, synthetic rubber-based, rubber-based and silicone-based pressure-sensitive adhesives for the pressure-sensitive adhesive layer in the present invention, and there is no particular limitation. From the viewpoints of transparency, heat resistance and the like, an acrylic pressure-sensitive adhesive containing an acrylic polymer as a base polymer is preferably used.

A raw material of the above acrylic pressure-sensitive adhesive preferably contains a (meth)acrylic monomer having an alkyl group of 1 to 14 carbon atoms as a constituent component. Use of the (meth)acrylic monomer is useful from the viewpoints of ease of handling and the like.

The (meth)acrylic monomer having an alkyl group of 1 to 14 carbon atoms can be used in the present invention, and a (meth)acrylic monomer having an alkyl group of 4 to 14 carbon atoms is more preferable. For example, there are suitably used methyl(meth)acrylate, ethyl(meth)acrylate, n-butyl(meth)acrylate, t-butyl(meth)acrylate, isobutyl(meth)acrylate, hexyl(meth)acrylate, 2-ethylhexyl(meth)acrylate, n-octyl(meth)acrylate, isooctyl(meth)acrylate, n-nonyl(meth)acrylate, isononyl(meth)acrylate, n-decyl(meth)acrylate, isodecyl(meth)acrylate, n-dodecyl(meth)acrylate, n-tridecyl(meth)acrylate, n-tetradecyl(meth)acrylate and the like. Among these (meth)acrylic monomers, n-butyl(meth)acrylate, 2-ethylhexyl(meth)acrylate and ethyl(meth)acrylate are particularly preferable. These (meth)acrylic monomers may be used alone, or two or more kinds of them may be used in combination.

A blending amount of the (meth)acrylic monomer having an alkyl group of 1 to 14 carbon atoms is preferably 50% by weight or more, more preferably from 60 to 100% by weight, and still more preferably from 70 to 98% by weight, in the monomer components.

It is possible to use, as other polymerizable monomers other than the (meth)acrylic monomer having an alkyl group of 1 to 14 carbon atoms, other monomers and the like for adjusting the glass transition point and releasability of the (meth)acrylic polymer as long as the effect of the present invention is not impaired. These monomers may be used alone, or in combination. A blending amount of the other polymerizable monomers is preferably 50% by weight or less, more preferably from 0 to 40% by weight, and still more preferably from 0 to 30% by weight, in the (entire) monomer component.

It is possible to appropriately use, as the other polymerizable monomers, components for improving cohesive strength and heat resistance, such as a sulfonic acid group-containing monomer, a phosphoric acid group-containing monomer, a cyano group-containing monomer, a vinyl ester monomer and an aromatic vinyl monomer; and monomer components having a functional group serving as a cross-linking base point, such as a hydroxyl group-containing monomer, a carboxyl group-containing monomer, an acid anhydride group-containing monomer, an amide group-containing monomer, an amino group-containing monomer, an epoxy group-containing monomer, N-acryloyl morpholine and a vinylether monomer. These monomers may be used alone, or two or more kinds of them may be used in combination.

Examples of the hydroxyl group-containing monomer include 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutyl vinyl ether, diethylene glycol monovinyl ether and the like.

Examples of the sulfonic acid group-containing monomer include styrenesulfonic acid, allylsulfonic acid, 2-(meth)acrylamide-2-methylpropanesulfonic acid, (meth) acrylamidepropanesulfonic acid, sulfopropyl(meth)acrylate, (meth)acryloyloxynaphthalenesulfonic acid and the like.

Examples of the phosphoric acid group-containing monomer include 2-hydroxyethylacryloyl phosphate.

Examples of the cyano group-containing monomer include acrylonitrile and the like.

Examples of the vinyl ester monomer include vinyl acetate, vinyl propionate, vinyl laurate and the like.

Examples of the aromatic vinyl monomer include styrene, chlorostyrene, chloromethylstyrene, a-methylstyrene and the like.

Examples of the carboxyl group-containing monomer include (meth)acrylic acid, carboxyethyl(meth)acrylate, carboxypentyl(meth)acrylate, itaconic acid, maleic acid, fumaric acid, crotonic acid and the like.

Examples of the acid anhydride group-containing monomer include maleic anhydride, itaconic anhydride and the like.

Examples of the amide group-containing monomer include acrylamide, diethylacrylamide and the like.

Examples of the amino group-containing monomer include N,N-dimethylaminoethyl(meth)acrylate, N,N-dimethylaminopropyl(meth)acrylate and the like.

Examples of the epoxy group-containing monomer include glycidyl(meth)acrylate, allyl glycidyl ether and the like.

Examples of the vinyl ether monomer include methyl vinyl ether, ethyl vinyl ether, isobutyl vinyl ether and the like.

The (meth)acrylic polymer to be used in the present invention preferably has a weight average molecular weight of 100,000 to 5,000,000, more preferably 200,000 to 4,000,000, and particularly preferably 300,000 to 3,000,000. In the case where the weight average molecular weight is less than 100,000, the adhesive power upon peeling increases due to an improvement in wettability to the thin layer base material (base material for optical device or the like) as an adherent, and therefore the adherend may be sometimes damaged in the peeling step (re-peeling), and further an adhesive residue tends to be generated due to small cohesive strength in the pressure-sensitive adhesive layer. On the other hand, in the case where the weight average molecular weight is more than 5,000,000, fluidity of the polymer decreases and wetting to the thin layer base material as the adherend becomes insufficient, and thus blister may tend to be generated between the adherend and the pressure-sensitive adhesive layer of the carrier material for a thin layer base material. The weight average molecular weight refers to a weight average molecular weight obtained by measuring through gel permeation chromatography (GPC).

Since it is easy to keep a balance of adherability, the above (meth)acrylic polymer preferably has a glass transition temperature (Tg) of 0° C. or lower (usually −100° C. or higher), more preferably −10° C. or lower, still more preferably −20° C. or lower, and particularly preferably −30° C. or lower. In the case where the glass transition temperature is higher than 0° C., the polymer is less likely to flow and wetting to the thin layer base material as the adherend becomes insufficient, and thus blister may tend to be generated between the adherend and the pressure-sensitive adhesive layer of the carrier material for a thin layer base material. The glass transition temperature (Tg) of the (meth)acrylic polymer can be adjusted within the above range by appropriately changing the monomer component to be used and the composition ratio.

There is no particular limitation on a method for polymerizing the (meth)acrylic polymer to be used in the present invention. It is possible to polymerize the (meth)acrylic polymer by known methods such as solution polymerization, emulsion polymerization, bulk polymerization and suspension polymerization, and solution polymerization is more preferable from the viewpoints of workability and the like. The polymer to be obtained may be any of a homopolymer, a random copolymer, a block copolymer and the like.

The pressure-sensitive adhesive layer to be used in the present invention becomes excellent in heat resistance by appropriately adjusting a component unit of the (meth)acrylic polymer, a constituent ratio, selection of a cross-linking agent, a blend ratio and the like, and appropriately cross-linking the (meth)acrylic polymer.

It is possible to use, as the cross-linking agent in the present invention, an isocyanate compound, an epoxy compound, a melamine-based resin, an aziridine compound, a metal chelate compound and the like. Among these cross-linking agents, an isocyanate compound and an epoxy compound are used particularly preferably from the viewpoint of obtaining moderate cohesive strength. These compounds may be used alone, or two or more kinds of them may be used in combination.

Examples of the isocyanate compound include lower aliphatic polyisocyanates such as butylene diisocyanate and hexamethylene diisocyanate; alicyclic isocyanates such as cyclopentylene diisocyanate, cyclohexylene diisocyanate and isophorone diisocyanate; aromatic isocyanates such as 2,4-tolylene diisocyanate, 4,4′-diphenylmethane diisocyanate and xylylene diisocyanate; and isocyanate adducts such as a trimethylolpropane/tolylene diisocyanate trimer adduct (trade name: CORONATE L, manufactured by Nippon Polyurethane Industry Co., Ltd.), a trimethylolpropane/hexamethylene diisocyanate trimer adduct (trade name: CORONATE HL, manufactured by Nippon Polyurethane Industry Co., Ltd.) and an isocyanurate compound of hexamethylene diisocyanate (trade name: CORONATE HX, manufactured by Nippon Polyurethane Industry Co., Ltd.). These compounds may be used alone, or two or more kinds of them may be used in combination.

Examples of the epoxy compound include N,N,N′,N′-tetraglycidyl-m-xylenediamine (trade name: TETRAD-X, manufactured by MITSUBISHI GAS CHEMICAL COMPANY, INC.), 1,3-bis(N,N-diglycidylaminomethyl)cyclohexane (trade name: TETRAD-C, manufactured by MITSUBISHI GAS CHEMICAL COMPANY, INC.) and the like. These compounds may be used alone, or two or more kinds of them may be used in combination.

Examples of the melamine-based resin include hexamethylolmelamine and the like. Examples of the aziridine derivative include a commercially available product under the trade name of HDU (manufactured by Sogo Pharmaceutical Co., Ltd.), a commercially available product under the trade name of TAZM (manufactured by Sogo Pharmaceutical Co., Ltd.), a commercially available product under the trade name of TAZO (manufactured by Sogo Pharmaceutical Co., Ltd.) and the like. These compounds may be used alone, or two or more kinds of them may be used in combination.

Examples of the metal chelate compound include aluminum, iron, tin, titanium, nickel and the like as metal components; and acetylene, methyl acetoacetate, ethyl lactate and the like as chelate components. These compounds may be used alone, or two or more kinds of them may be used in combination.

In the present invention, it is possible to blend a polyfunctional monomer having two or more radiation-reactive unsaturated bonds as a cross-linking agent. In such a case, a (meth)acrylic polymer is cross-linked by irradiation with radiation. Examples of the polyfunctional monomer having two or more radiation-reactive unsaturated bonds in a molecule include polyfunctional monomers having two or more radiation-reactive unsaturated bonds of one or two or more kinds which can be cross-linked (cured) by irradiation with radiation, such as a vinyl group, an acryloyl group, a methacryloyl group and a vinylbenzyl group. Generally, those having ten or less radiation-reactive unsaturated bonds are suitably used as the polyfunctional monomer. These compounds may be used alone, or two or more kinds of them may be used in combination.

Specific examples of the polyfunctional monomer include ethylene glycol di(meth)acrylate, diethylene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinyl benzene, N,N′-methylenebisacrylamide and the like.

A blending amount of the cross-linking agent to be used in the present invention is preferably from 1 to 30 parts by weight, and more preferably from 2 to 25 parts by weight, based on 100 parts by weight (solid content) of the (meth)acrylic polymer. When the blending amount is less than 5 parts by weight, formation of cross-linking by the cross-linking agent becomes insufficient, and thus the cohesive strength of the pressure-sensitive adhesive layer decreases and sufficient heat resistance may not be sometimes obtained, and further there is a tendency of a cause of an adhesive residue. On the other hand, when the blending amount is more than 30 parts by weight, the cohesive strength of the pressure-sensitive adhesive layer is large and fluidity decreases, and thus wetting to the thin layer base material as the adherend becomes insufficient and blister may tend to be generated between the adherend and the pressure-sensitive adhesive layer, this is unfavorable. These cross-linking agents may be used alone, or two or more kinds of them may be used in combination.

Examples of the radiation include ultraviolet rays, laser beams, α-rays, β-rays, γ-rays, X-rays, electron beams and the like, and ultraviolet rays are suitably used from the viewpoints of controllability, satisfactory handleability and costs. More preferably, ultraviolet rays having a wavelength of 200 to 400 nm are used. It is possible to irradiate ultraviolet rays using appropriate light sources such as a high-pressure mercury lamp, a microwave-excited type lamp and a chemical lamp. In the case of using ultraviolet rays as the radiation, a photopolymerization initiator is blended with an acrylic pressure-sensitive adhesive.

The photopolymerization initiator may be a substance which forms a radical or cation by irradiation with ultraviolet rays having an appropriate wavelength which can cause a polymerization reaction according to the kind of a radiation-reactive component.

Examples of the photoradical polymerization initiator include benzoins such as a benzoin, a benzoin methyl ether, a benzoin ethyl ether, an o-methylbenzoyl benzoate-p-benzoin ethyl ether, a benzoin isopropyl ether and α-methylbenzoin; acetophenones such as benzyl dimethyl ketal, trichloroacetophenone, 2,2-diethoxyacetophenone and 1-hydroxycyclohexyl phenyl ketone; propiophenones such as 2-hydroxy-2-methylpropiophenone and 2-hydroxy-4′-isopropyl-2-methylpropiophenone; benzophenones such as benzophenone, methylbenzophenone, p-chlorobenzophenone and p-dimethylaminobenzophenone; thioxanthones such as 2-chlorothioxanthone, 2-ethylthioxanthone and 2-isopropylthioxanthone; acylphosphine oxides such as bis(2,4,6-trimethylbenzoyl)-phenylphosphine oxide, 2,4,6-trimethylbenzoylphenylphosphine oxide and (2,4,6-trimethylbenzoyl)-(ethoxy)-phenylphosphine oxide; benzyl, dibenzosuberone, α-acyloxime ester and the like. These compounds may be used alone, or two or more kinds of them may be used in combination.

Examples of the photocation polymerization initiator include onium salts such as an aromatic diazonium salt, an aromatic iodonium salt and an aromatic sulfonium salt; organic metal complexes such as an iron-allene complex, a titanocene complex and an arylsilanol-aluminum complex; a nitrobenzyl ester, a sulfonic acid derivative, a phosphoric acid ester, a phenolsulfonic acid ester, diazonaphthoquinone and N-hydroxyimide sulfonate. These compounds may be used alone, or two or more kinds of them may be used in combination. The photopolymerization initiator is usually blended in an amount of 0.1 to 10 parts by weight, and preferably 0.2 to 7 parts by weight, based on 100 parts by weight of the (meth)acrylic polymer.

It is also possible to use in combination with auxiliary photopolymerization initiators such as amines. Examples of the auxiliary photopolymerization initiator include 2-dimethylaminoethyl benzoate, dimethylaminoacetophenone, ethyl p-dimethylaminobenzoate, isoamyl p-dimethylaminobenzoate and the like. These compounds may be used alone, or two or more kinds of them may be used in combination. The auxiliary photopolymerization initiator is preferably blended in an amount of 0.05 to 10 parts by weight, and more preferably 0.1 to 7 parts by weight, based on 100 parts by weight of the (meth)acrylic polymer.

The raw material (pressure-sensitive adhesive composition) of the pressure-sensitive adhesive (layer) to be used in the present invention may contain other known additives. For example, it is possible to appropriately blend powders such as a colorant and a pigment, a surfactant, a plasticizer, a tackifier, a low-molecular weight polymer, a surface lubricant, a leveling agent, an antioxidant, a corrosion inhibitor, a photostabilizer, an ultraviolet absorber, a polymerization inhibitor, a silane coupling agent, an inorganic or organic filler, a metal powder, a granule and a foil-shaped substance according to the use applications.

The pressure-sensitive adhesive layer to be used in the present invention is formed by cross-linking the above-mentioned raw material (pressure-sensitive adhesive composition) of the pressure-sensitive adhesive (layer). The carrier material for a thin layer base material of the present invention is obtained by forming such a pressure-sensitive adhesive layer on a support (base material layer). In that case, the pressure-sensitive adhesive composition is generally cross-linked after applying the pressure-sensitive adhesive composition. It is also possible to transfer a pressure-sensitive adhesive layer made of the pressure-sensitive adhesive composition after cross-linking to a support and the like.

In the case of blending the photopolymerization initiator serving as an optional component mentioned above, the pressure-sensitive adhesive composition is directly applied on the carrier material for a thin layer base material (adherend) or irradiated with light after applying the composition on one or both surfaces of the support (base material layer), and thus a pressure-sensitive adhesive layer can be obtained. Usually, a pressure-sensitive adhesive layer can be obtained by photopolymerization through irradiation with ultraviolet rays having an illuminance of 1 to 200 mW/cm² at a wavelength of 300 to 400 nm in a dose of about 400 to 4,000 mJ/cm².

There is no particular limitation on a method of forming a pressure-sensitive adhesive layer on a support (base material layer) and, for example, the pressure-sensitive adhesive composition is applied on a support and the polymerization solvent or the like is dried and removed to form a pressure-sensitive adhesive layer on the support. Thereafter, aging may be performed for the purpose of adjusting transfer of the component of the pressure-sensitive adhesive layer and adjusting the cross-linking reaction. In the case of producing a carrier material for a thin layer base material by applying the pressure-sensitive adhesive composition on the support, one or more kinds of solvents other than the polymerization solvent may be newly added to the pressure-sensitive adhesive composition so as to be uniformly applied on the support.

It is possible to use, as the method of forming a pressure-sensitive adhesive layer in the present invention, a known method to be used in the production of a pressure-sensitive adhesive tape or the like. Specific examples thereof include roll coating, gravure coating, reverse coating, roll brushing, spray coating, and air knife coating methods and the like.

The carrier material for a thin layer base material of the present invention is produced so that the pressure-sensitive adhesive layer usually has a thickness of 3 to 100 μm, and preferably about 5 to 50 μm. The pressure-sensitive adhesive composition is applied or the like on at least one surface of a support (base material layer) to be used in the present invention to form the pressure-sensitive adhesive layer in the form of a film, sheet, tape or the like.

The pressure-sensitive adhesive layer to be used in the present invention preferably has an initial adhesive power (after 30 minutes at 23° C.) of 0.5 N/25 mm or less, more preferably 0.01 to 0.4 N/25 mm, and particularly preferably 0.02 to 0.3 N/25 mm. When the initial adhesive power is within the above range, deformation or the like of the shape of the thin layer base material does not occur in the case of peeling the carrier material for a thin layer base material from the thin layer base material, resulting in a preferred aspect.

The pressure-sensitive adhesive layer to be used in the present invention preferably has a daily adhesive power (heating conditions: after 48 hours (2 days) at 50° C.) of 0.5 N/25 mm or less, more preferably 0.01 to 0.45 N/25 mm, and particularly preferably 0.02 to 0.35 N/25 mm. When the daily adhesive power is within the above range, deformation or the like of the shape of the thin layer base material does not occur even after exposure under heating conditions, resulting in a preferred aspect.

In the present invention, a polyester-based resin is used as a material of the support constituting the carrier material for a thin layer base material. Since the polyester-based resin has strong toughness, processability, transparency and the like, workability and inspectability are improved by using the polyester-based resin as the carrier material for a thin layer base material, resulting in a preferred aspect.

There is no particular limitation on the polyester-based resin as long as it can be formed into a sheet, film or the like, and examples thereof include polyester films made of polyethylene terephthalate, polyethylene naphthalate or polybutylene terephthalate. These polyester-based resins may be used alone (homopolymer), or two or more kinds of them may be used in combination after polymerization (copolymer, etc.). In the present invention, since the polyester-based resin is particularly used as the carrier material for a thin layer base material, polyethylene terephthalate is preferably used as the material of the support. Therefore, when polyethylene terephthalate is used, the obtained carrier material for a thin layer base material is excellent in strong toughness, processability and transparency and thus workability are improved, resulting in a preferred aspect.

The support has a thickness of 50 to 150 μm, preferably from 60 to 140 μm, and particularly preferably from 70 to 130 μm. When the thickness is within the above range, it is possible to retain a shape of the thin layer base material which has no stiffness and is likely to be flexible by using the carrier material for a thin layer base material in the state of bonding to the thin layer base material, and generation of defects such as wrinkles and scratches in processing step, transporting step and the like can be prevented. Therefore, the carrier material for a thin layer base material is useful.

The support may be optionally subjected to a mold release treatment, an antifouling treatment and an acid treatment using a silicone-based, fluorine-based, long chain alkyl-based or fatty acid amide-based mold releasing agent, silica powder or the like; an easy adhesion treatment such as an alkali treatment, a primer treatment, a corona treatment, a plasma treatment or an ultraviolet treatment, and an electrostatic treatment such as a coating, kneading or vapor deposition treatment.

In order to improve adhesion between the pressure-sensitive adhesive layer and the support, a surface of the support may be subjected to a corona treatment or the like. The support may be subjected to a rear surface treatment.

The total of a breaking strength in a first direction and a breaking strength in a second direction perpendicularly intersecting with the first direction of the support is preferably from 300 to 700 N/10 mm, more preferably from 300 to 650 N/10 mm, and particularly preferably from 310 to 600 N/10 mm. When the total is within the above range, the support per se has stiffness and the strength of the entire material including the thin layer base material is improved by bonding a carrier material for a thin layer base material using this support to the thin layer base material, and thus deformation (curl, etc.) of the shape of the thin layer base material in processing step, transporting step or the like is suppressed, resulting in a preferred aspect. The first direction may be either the longitudinal direction (MD) or the width direction (TD, namely, direction orthogonal to MD) of the support. In the case where the first direction is the MD direction, the second direction refers to the TD direction.

It is possible to bond a separator on a surface of a pressure-sensitive adhesive of the carrier material for a thin layer base material of the present invention for the purpose of optionally protecting a pressure-sensitive adhesive surface. The base material constituting the separator includes paper and a plastic film, and a plastic film is suitably used from the viewpoint of excellent surface smoothness. There is no particular limitation on the film as long as it is a film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinyl acetate copolymer film and the like.

Examples of the thin layer base material to be used in the carrier material for a thin layer base material of the present invention include a resin film made of an acrylic resin, polycarbonate or polyethylene terephthalate (PET); an ITO-deposited resin film; a base material made of glass or metal thin film (for example, sheet-like, film-like or plate-like base material (member)) and the like, and particularly a resin film.

The above thin layer base material is more preferably a base material for an optical device (optical member). Herein, the base material for an optical device refers to a base material (member) having, for example, optical characteristics (for example, polarizability, photorefractivity, light scattering property, light reflection property, optical transparency, optical absorption property, optical diffraction property, optical rotation, and visibility). There is no particular limitation on the base material for an optical device, as long as it is a base material having optical characteristics, and examples thereof include a base material (member) constituting devices such as display devices (liquid crystal display devices, organic EL (electroluminescence) display devices, plasma display panels (PDPs), electronic paper, etc.) and input devices (touch panels, etc.) and a base material (member) to be used in these devices, and specific examples thereof include a polarizing plate, a wavelength plate, a retardation plate, an optical compensation film, a brightness enhancement film, a light-guiding plate, a reflection film, an anti-reflective film, a transparent conductive film (ITO film, etc.), a design film, a decorative film, a surface protective film, a prism, a color filter, a hard coat film, a transparent substrate, and a member on which these are laminated. The above “plate” and “film” also include forms such as plate-like, film-like and sheet-like forms and, for example, a “polarizing plate” also includes a “polarizing film” and a “polarizing sheet”. These base materials for an optical device are likely to cause flexibility and deformation of shape in processing step, transporting step or the like because of small thickness and no stiffness. However, use of the carrier material for a thin layer base material of the present invention enables retention of its shape and suppression of generation of defects, resulting in a preferred aspect.

It is preferred to use the thin layer base material having a thickness of 50 μm or less, and more preferably 40 μm or less. Use of the carrier material for a thin layer base material of the present invention to a thin layer base material (adherend) having a thickness within the above range enables retention of a shape of a very thin layer base material and suppression of generation of defects such as wrinkles and scratches, resulting in a preferred aspect.

### EXAMPLES

Examples and the like specifically illustrating the constitution and effect of the present invention will be descried below, but the present invention is not limited thereto. Evaluation items in Examples and the like were measured by the following procedures. The evaluation results are shown in Table 1.

### Example 1

### Preparation of Acrylic Polymer (A)

In a four-necked flask equipped with a stirring blade, a thermometer, a nitrogen gas introducing tube and a condenser, 200 parts by weight of 2-ethylhexyl acrylate, 8 parts by weight of 2-hydroxyethyl acrylate, 0.4 parts by weight of 2,2′-azobisisobutyronitrile as a polymerization initiator and 312 parts by weight of ethyl acetate were charged and a nitrogen gas was introduced while stirring mildly. Then, a polymerization reaction was performed for about 6 hours while maintaining a liquid temperature inside the flask at about 65° C. to prepare an acrylic polymer (A) solution (40% by weight). The acrylic polymer (A) had a weight average molecular weight of 500,000 and a glass transition temperature (Tg) of −68° C.

### <Preparation of Pressure-Sensitive Adhesive Solution>

The above acrylic polymer (A) solution (40% by weight) was diluted with ethyl acetate to give a solution (20% by weight), and then 4.0 parts by weight of polyisocyanate (CORONATE HX, manufactured by Nippon Polyurethane Industry Co., Ltd.) as a cross-linking agent and 0.02 parts by weight of dibutyltin dilaurate (1% by weight ethyl acetate solution) were added based on 100 parts by weight (solid content) of the acrylic polymer of the solution. After mixing and stirring for about 1 minute while maintaining at about 25° C., an acrylic pressure-sensitive adhesive solution (1) was prepared.

### <Production of Carrier Material for Thin Layer Base Material>

The above acrylic pressure-sensitive adhesive solution (1) was applied on one surface of a polyethylene terephthalate (PET) base material (thickness: 75 μm, support) and then heated at 110° C. for 3 minutes to form a pressure-sensitive adhesive layer having a thickness of 15 μm. Then, a silicon-treated surface of a PET liner (thickness: 25 μm) whose one surface had been subjected to a silicone treatment was bonded on a surface of the pressure-sensitive adhesive layer to produce a carrier material for a thin layer base material.

### Example 2

A carrier material for a thin layer base material was produced in the same manner as in Example 1 except that a PET base material having a thickness of 100 μm was used.

### Example 3

A carrier material for a thin layer base material was produced in the same manner as in Example 1 except that a PET base material having a thickness of 125 μm was used.

### Comparative Example 1

A carrier material for a thin layer base material was produced in the same manner as in Example 1 except that a PET base material having a thickness of 38 μm was used.

### Comparative Example 2

A carrier material for a thin layer base material was produced in the same manner as in Example 1 except that a polyethylene (PE) base material (thickness: 75 μm, ANE-75, manufactured by Aichi Plastics Industry Co., Ltd.) was used in place of the PET base material.

### Comparative Example 3

### Preparation of Rubber-Based Pressure-Sensitive Adhesive Solution

One hundred Parts by weight of a natural rubber-based graft copolymer (MEGAPOLY 30, manufactured by ASIATIC DEVELOPMENT BHD), 35 parts by weight of an aliphatic tackifier (Quintone A-100, manufactured by Zeon Corporation) and 4.0 parts by weight of polyisocyanate (MILLIONATE MR-2005, manufactured by Nippon Polyurethane Industry Co., Ltd.) as a cross-linking agent were charged in a vessel, and then the solution was diluted with toluene to give a solution (10% by weight). After mixing and stirring for about 20 minutes while maintaining at about 25° C., a rubber-based pressure-sensitive adhesive solution (2) was prepared.

### <Production of Carrier Material for Thin Layer Base Material>

The above rubber-based pressure-sensitive adhesive solution (2) was applied on one surface of a polyethylene (PE) base material (thickness: 75 μm, ANE-75, manufactured by Aichi Plastics Industry Co., Ltd.) and then heated at 80° C. for 2 minutes to form a pressure-sensitive adhesive layer having a thickness of 10 μm. Then, a silicon-treated surface of a PET release liner (thickness: 25 μm) whose one surface had been subjected to a silicone treatment was bonded on a surface of the pressure-sensitive adhesive layer to produce a carrier material for a thin layer base material.

### Example 4

### Preparation of Raw Solution of Primer

A natural rubber (International Standard RSS-3 type) was diluted with toluene to give a solution (20% by weight). After mixing and stirring for about 20 hours while maintaining at about 25° C., a raw solution (20% by weight) of a primer was prepared.

### <Preparation of Primer>

The raw solution (20% by weight) of a primer was diluted with toluene to give a solution (0.5% by weight), and then 75 parts by weight (in terms of the solid content) of polyisocyanate (CORONATE L, manufactured by Nippon Polyurethane Industry Co., Ltd.) was added based on 100 parts by weight (in terms of the solid content) of the natural rubber (International Standard RSS-3 type) in this solution. After mixing and stirring for about 1 minute while maintaining at about 25° C., a primer was prepared.

### <Production of Carrier Material for Thin Layer Base Material>

The above primer was applied on one surface of a PET base material (thickness: 125 μm) and then heated at 80° C. for 1 minute to form a primer layer having a thickness of 0.4 μm. Then, the rubber-based pressure-sensitive adhesive solution (2) similar to Comparative Example 3 was applied on the primer layer and then heated at 80° C. for 2 minutes to form a rubber-based pressure-sensitive adhesive layer having a thickness of 3 μm. Then, a silicon-treated surface of a PET release liner (thickness: 25 μm) whose one surface had been subjected to a silicone treatment was bonded on a surface of the pressure-sensitive adhesive layer to produce a carrier material for a thin layer base material.

### <Measurement of Weight Average Molecular Weight (Mw) of Acrylic Polymer (A)>

A weight average molecular weight of the thus produced polymer was measured by gel permeation chromatography (GPC).

Apparatus: HLC-8220GPC manufactured by TOSOH CORPORATION Column:
Sample column; TSKguardcolumn Super HZ-H (one column) and TSKgel Super HZM-H (two columns), manufactured by TOSOH CORPORATION
Reference column; TSKgel Super H—RC (one column), manufactured by TOSOH CORPORATION
Flow rate: 0.6 ml/minute
Injection amount: 10 μl
Column temperature: 40° C.

### Eluent: THF

Concentration of injected sample: 0.2% by weight
Detector: differential refractometer

The weight average molecular weight was calculated in terms of polystyrene.

### <Measurement of Glass Transition Temperature (Tg) of Acrylic Polymer (A)>

A glass transition temperature Tg (° C.) was determined by the following equation using the following literature value as the glass transition temperature Tgn (° C.) of a homopolymer by each monomer.

Equation: 1/(Tg+273)=Σ[Wn/(Tgn+273)]

wherein Tg (° C.) denotes a glass transition temperature of a copolymer, Wn (−) denotes a weight fraction of each monomer, Tgn (° C.) denotes a glass transition temperature of a homopolymer by each monomer, and n denotes a kind of each monomer.

2-ethylhexyl acrylate: −70° C.

2-hydroxyethyl acrylate: −15° C.

Butyl acrylate: −55° C.

Acrylic acid: 106° C.

“Synthesis/Design and Development of New Application of Acrylic Resin” (published by Publishing Department of Chubu Management Development Center) was referred as the literature value.

### <Breaking Strength>

A breaking strength was measured by the following method. That is, a strip-shaped test piece (MD test piece) was cut out from a support along the longitudinal direction (MD), and then a tensile strength at break of the test piece and a distance between chucks were measured under the following conditions in accordance with JIS K7127 (1999).

### [Measurement Conditions]

Measurement temperature: 23° C. (measurement was initiated after maintaining the test piece for 30 minutes or more under the conditions at 23° C. and 50% RH)

Width of test piece: 10 mm

Tensile speed: 300 mm/m

Distance between chucks: 50 mm

Using three test pieces cut out from different positions, the measurement was performed (that is, n=3), and an average thereof was regarded as the breaking strength (N/10 mm) of MD.

A strip-shaped test piece (TD test piece) was cut out from a support along the width direction (TD, that is, a direction orthogonal to MD), and then a breaking strength was measured in the same manner as in the case of the MD test piece. Using three test pieces cut out from different positions, the measurement was performed, and an average thereof was regarded as the breaking strength (N/10 mm) of TD.

### <Measurement of Adhesive Power>

### [Initial Adhesive Power]

An acrylic plate measuring 70 mm in width and 100 mm in length (ACRYLITE, manufactured by MITSUBISHI RAYON CO., LTD.) was prepared as an adherend. A carrier material for a thin layer base material (pressure-sensitive adhesive sheet) was cut into a size measuring 25 mm in width and 100 mm in length every release liner and the release liner was removed thereby exposing a pressure-sensitive adhesive surface. The pressure-sensitive adhesive surface was press-contacted on the acrylic plate at a linear pressure of 78.5 N/cm and a speed of 0.3 m/minute. After being left to stand under an atmosphere at 23° C. and 50% RH for 30 minutes, the carrier material for a thin layer base material was peeled from the acrylic plate under the conditions of a peel rate of 0.3 m/minute and a peel angle of 180° in the same atmosphere using a universal tensile testing machine. At this time, the peel force was evaluated as an initial adhesive power.

### [Measurement of Daily Adhesive Power]

An acrylic plate measuring 70 mm in width and 100 mm in length (ACRYLITE, manufactured by MITSUBISHI RAYON CO., LTD.) was prepared as an adherend. A carrier material for a thin layer base material (pressure-sensitive adhesive sheet) was cut into a size measuring 25 mm in width and 100 mm in length every release liner and the release liner was removed thereby exposing a pressure-sensitive adhesive surface. The pressure-sensitive adhesive surface was press-contacted on the acrylic plate at a pressure of 0.25 MPa and a speed of 0.3 m/minute. After being left to stand under an atmosphere at 50° C. for 48 hours and left to stand under an atmosphere at 23° C. and 50% RH for 30 minutes, the carrier material for a thin layer base material was peeled from the acrylic plate under the conditions of a peel rate of 0.3 m/minute and a peel angle of 180° in the same atmosphere using a universal tensile testing machine (tensile and compression testing machine, manufactured by Minebea Co., Ltd.). At this time, the peel force was evaluated as a daily adhesive power.

### <Confirmation of Shape Retention of Processed Surface]

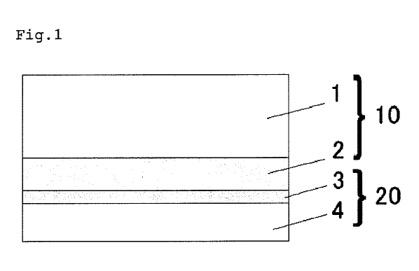

Each carrier material for a thin layer base material (pressure-sensitive adhesive sheet) of Examples and Comparative Examples was bonded to an ITO film having a thickness of about 25 μm (thin layer base material: an ultra-thin ITO layer was formed on a PET base material having a thickness of about 25 μm). After maintaining at 150° C. for 60 minutes in the state where the ITO film was bonded on a top surface of the carrier material for a thin layer base material (pressure-sensitive adhesive sheet) and returning to room temperature (23° C.), the ITO film was visually observed. A non-curled ITO film was rated “Good”, whereas, a curled ITO film was rated “Poor”. The state of bonding the ITO film is shown in FIG. 1 (one example).

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Constitution | Support | PET | PET | PET | PET | PET | PE | PE |
| | Thickness of | 75 | 100 | 125 | 125 | 38 | 75 | 75 |
| | support (μm) | | | | | | | |
| | Pressure- | Acrylic | Acrylic | Acrylic | Rubber- | Acrylic | Acrylic | Rubber- |
| | sensitive | pressure- | pressure- | pressure- | based | pressure- | pressure- | based |
| | adhesive | sensitive | sensitive | sensitive | pressure- | sensitive | sensitive | pressure- |
| | | adhesive | adhesive | adhesive | sensitive | adhesive | adhesive | sensitive |
| | | | | | adhesive | | | adhesive |
| | Thickness of | 15 | 15 | 15 | 3 | 15 | 15 | 10 |
| | pressure- | | | | | | | |
| | sensitive | | | | | | | |
| | adhesive (μm) | | | | | | | |
| Breaking | MD direction | 162.8 | 219.0 | 267.5 | 271.5 | 85.1 | 20.1 | 20.3 |
| strength | TD direction | 168.0 | 225.0 | 270.0 | 269.8 | 91.2 | 16.3 | 15.8 |
| (N/10 mm) | MD + TD | 330.8 | 444.0 | 537.5 | 541.3 | 176.3 | 36.4 | 36.1 |
| | (total) | | | | | | | |
| Adhesive | Initial | 0.11 | 0.10 | 0.10 | 0.10 | 0.12 | 0.12 | 0.80 |
| power | at 23° C. for | | | | | | | |
| (N/25 mm) | 30 minutes | | | | | | | |
| | Daily | 0.12 | 0.11 | 0.10 | 0.12 | 0.12 | 0.13 | 0.90 |
| | at 50° C. for | | | | | | | |
| | 48 hours | | | | | | | |
| Adhesive | Daily/Initial | 1.1 | 1.1 | 1.0 | 1.2 | 1.0 | 1.1 | 1.1 |
| power ratio | | | | | | | | |

| | | | | | | | |
|---|---|---|---|---|---|---|---|
| Shape retention of | Good | Good | Good | Good | Poor | Poor | Poor |
| processed surface | | | | | | | |

The results of Table 1 described above revealed that a carrier material for a thin layer base material, which is excellent in breaking strength (stiffness of support) and adhesive power (suppression of change in adhesive power) and also can retain a shape of a processed surface, could be obtained by adjusting the thickness of the support within a desired rage in all Examples. On the other hand, in Comparative Example 1, since the thickness of the support was not adjusted within a desired range, the total of the breaking strength decreased and stiffness was not exhibited, and also the shape of the processing surface could not be retained. In Comparative Examples 2 and 3, the thickness of the support was the same as in Example 1. However, since a polyethylene-based resin was used in place of a polyester-based resin, shape retention of the processed surface was inferior as compared with Examples due to low breaking strength and no stiffness. In Comparative Example 3, since a rubber-based pressure-sensitive adhesive having high adhesive power was used in the pressure-sensitive adhesive layer, the thin layer base material was deformed in the case of peeling from the thin layer base material.

### EXPLANATION OF REFERENCE NUMERALS

1 Support (PET)
2 Pressure-sensitive adhesive layer
3 ITO layer
4 PET base material
10 Carrier material for thin layer base material
20 ITO film (thin layer base material)

1. A carrier material for a thin layer base material, comprising a support having a thickness of 50 to 150 μm and formed from a polyester-based resin, and a pressure-sensitive adhesive layer formed on at least one surface of the support.

2. The carrier material for a thin layer base material according to claim 1, wherein the total of a breaking strength in a first direction and a breaking strength in a second direction perpendicularly intersecting with the first direction of the support is from 300 to 700 N/10 mm.

3. The carrier material for a thin layer base material according to claim 1, wherein the pressure-sensitive adhesive layer has an initial adhesive power (after 30 minutes at 23° C.) of 0.5 N/25 mm or less.

4. The carrier material for a thin layer base material according to claim 1, wherein the support contains polyethylene terephthalate.

5. The carrier material for a thin layer base material according to claim 1, wherein the thin layer base material is a resin film.

6. The carrier material for a thin layer base material according to claim 1, wherein the thin layer base material is a base material for an optical device.
